(19) United States
(12) Patent Application Publication
(10) Pub. No.: US 2014/0054814 A1
(43) Pub. Date: Feb. 27, 2014

(54) METHOD FOR MANUFACTURING ELECTRONIC DEVICE CASING

(71) Applicants: RUNG-AN CHEN, Tu-Cheng (TW); HENG-SHENG LIN, Tu-Cheng (TW)

(72) Inventors: RUNG-AN CHEN, Tu-Cheng (TW); HENG-SHENG LIN, Tu-Cheng (TW)

(21) Appl. No.: 13/659,847

(22) Filed: Oct. 24, 2012

(30) Foreign Application Priority Data
Aug. 22, 2012 (TW) 101130340

(51) Int. Cl. B29C 41/30

(52) U.S. Cl. 264/46.4

(57) ABSTRACT

An exemplary method for manufacturing a thermally insulating electronic device casing includes the following steps. First, a cover and a mold are provided. The cover includes a top surface. The mold includes a bottom surface, and the bottom surface of the mold is depressed inwardly thereby defining a recess. Next, the mold is arranged to cover the cover, with the bottom surface of the mold attached on the top surface of the cover. Thereby, a room is cooperatively defined by the recess and the top surface of the cover. Then the room is filled with aerogel solution. After that, the aerogel solution in the room is dried. Finally, the mold is and removed from the cover.

### BACKGROUND

1. Technical Field

The disclosure relates to methods for manufacturing casings adapted for electronic devices, and more particularly, to a method for manufacturing a heat insulating casing of an electronic device.

2. Description of Related Art

In many electronic devices such as portable electronic devices, the casing of the electronic device is easily handled by users. However, during operation of many electronic devices, heat is generated by heat generating electronic components inside the casing and then transferred to the casing. This may make users uncomfortable. Therefore, a heat insulation layer is usually provided on an inner side of the casing to avoid overheating of the casing.

A conventional casing employs sponge or rubber as the material of the heat insulation layer. However, sponge and rubber have the following disadvantages. Firstly, the typical insulation effect of sponge and rubber is not good, at least in some applications. Secondly, sponge and rubber easily deteriorate under high temperatures. Thirdly, the insulation effect of sponge and rubber decreases significantly in unfavorable ambient environment conditions. Fourthly, sponge and rubber provide sufficient insulation effect only when the layer has a large thickness. That is, sponge and rubber are not suitable for miniaturized electronic devices.

What is needed, therefore, is a method for manufacturing a casing which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views, and all the views are schematic.

FIG. 1 is an isometric, assembled view of a casing made by a method in accordance with an embodiment of the disclosure.

FIG. 2 is an isometric view of one stage in the method for manufacturing the casing of FIG. 1, showing a mold inverted.

FIG. 3 is an isometric view of another stage in the method for manufacturing the casing of FIG. 1, showing the mold upright.

### DETAILED DESCRIPTION

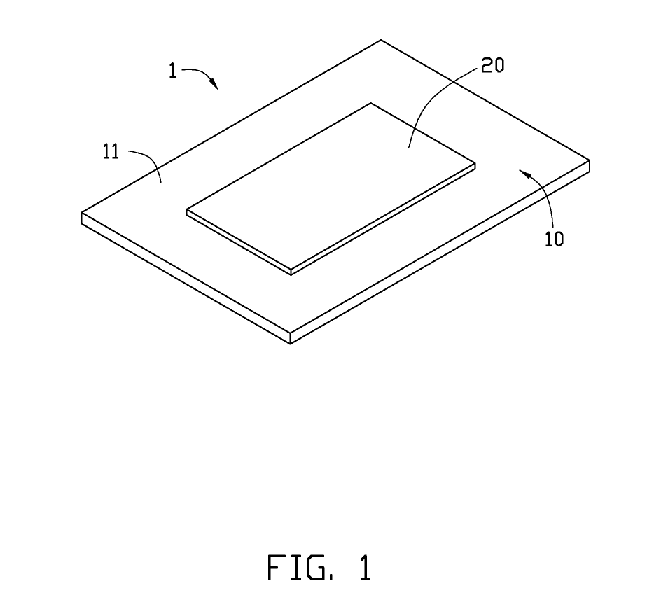

Referring to FIG. 1, this shows a casing 1 made by a method in accordance with an embodiment of the present disclosure. The casing 1 includes a cover 10, and an aerogel layer 20 attached to the cover 10.

The cover 10 is a thin plate, and includes a top surface 11.

The aerogel layer 20 is a sheet, and located on the top surface 11 of the cover 10. In this embodiment, the aerogel layer 20 is directly attached on the top surface 11 of the cover 10. Alternatively, the aerogel layer 20 is placed on another device or structure, and then the other device or structure is placed on the top surface 11 of the cover 10.

The cover 10 with the aerogel layer 20 thereon has the following advantages:

Firstly, the insulation effect of the aerogel layer 20 is good, even if a thickness of the aerogel layer 20 is relatively small.

Secondly, the aerogel layer 20 resists deterioration under high temperatures.

Thirdly, the aerogel layer 20 is waterproof, and the insulation effect of the aerogel layer 20 remains substantially the same even in unfavorable ambient environment conditions.

Fourthly, the density of the aerogel layer 20 is low, so the aerogel layer 20 is light.

The casing 1 described above can be manufactured by the following steps:

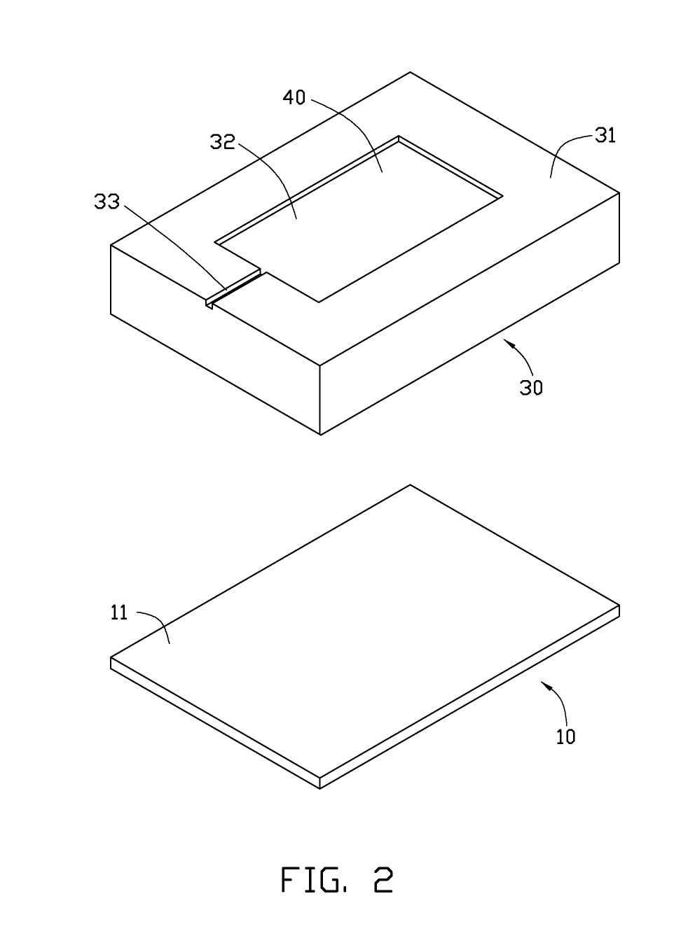

Referring to FIG. 2, a cover 10 and a mold 30 are provided. The cover 10 is a thin plate, and includes a top surface 11. The mold 30 is generally cuboid shaped, and includes a bottom surface 31. A middle of the bottom surface 31 of the mold 30 is depressed inwardly to define a recess 32, and the recess 32 is communicated with a lateral exterior of the mold 30 via a guiding groove 33.

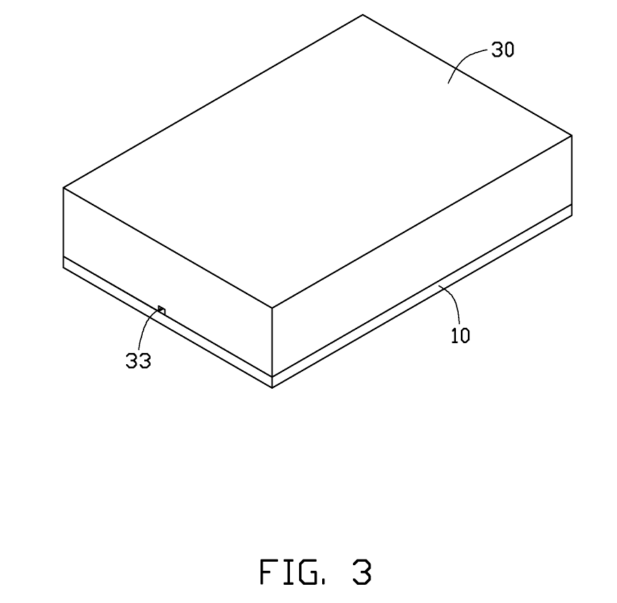

Referring to FIG. 3, the mold 30 is arranged to cover the cover 10, and the bottom surface 31 of the mold 30 is attached on the top surface 11 of the cover 10. Thus, the recess 32 of the mold 30 and the top surface 11 of the cover 10 cooperatively define a room 40, with the room 40 in communication with the exterior of the mold 30 via the guiding groove 33.

Aerogel solution is filled into the room 40 via the guiding groove 33, and then the aerogel solution filled in the room 40 is dried. In this embodiment, the aerogel solution filled in the room 40 is dried by a carbon dioxide supercritical drying method, which method ensures that the dried aerogel has a three-dimensional porous structure.

The mold 30 is removed from the cover 10 after the aerogel solution is dried completely. Thus the aerogel layer 20 is obtained, with the aerogel layer 20 being firmly attached to the top surface 11 of the cover 10.

It is understood that the size and shape of the aerogel layer 20 can be adjusted according to actual conditions, by changing the size and shape of the room 40.

In the method for manufacturing the casing 1 described above, the room 40 contains the unformed aerogel solution ready for the subsequent drying process. This enables the aerogel material to be easily shaped as desired.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being illustrative embodiments.

What is claimed is:

1. A method for manufacturing a casing adapted for an electronic device, the method comprising:
providing a cover and a mold, the cover comprising a top surface, the mold comprising a bottom surface, the bottom surface of the mold being depressed inwardly thereby defining a recess;
arranging the mold to cover the cover, with the bottom surface of the mold attached on the top surface of the cover, and a room being cooperatively defined by the recess and the top surface of the cover;
filling the room with aerogel solution, and drying the aerogel solution in the room; and
removing the mold from the cover.

2. The method of claim 1, wherein the recess is defined in a middle of the bottom surface of the mold, and the recess is communicated with an exterior of the mold via a guiding groove defined in the mold.

3. The method of claim 1, wherein the aerogel solution in the room is dried by a carbon dioxide supercritical drying method.

4. A method for manufacturing a casing adapted for an electronic device, the method comprising:
providing a cover and a mold, the mold being depressed inwardly thereby defining a recess;
covering the recess of the mold with the cover, with the cover attached to the mold, and a room being cooperatively defined by the recess and the cover;
filling the room with aerogel solution;
drying the aerogel solution in the room; and
removing the mold from the cover.

5. The method of claim 4, wherein the recess is defined in a middle of a major surface of the mold, and the recess is communicated with an exterior of the mold via a guiding groove defined in the mold.

6. The method of claim 4, wherein the aerogel solution in the room is dried by a carbon dioxide supercritical drying method.

7. A method for manufacturing a casing adapted for an electronic device, the method comprising:
providing a workpiece and a mold, the workpiece comprising a top surface, the mold comprising a bottom surface, the bottom surface of the mold being depressed inwardly thereby defining a recess;
arranging the mold to cover the workpiece, with the bottom surface of the mold attached on the top surface of the workpiece, and a room being cooperatively defined by the recess and the top surface of the workpiece;
filling the room with aerogel solution, and drying the aerogel solution in the room; and
removing the mold from the cover.

8. The method of claim 7, wherein the recess is defined in a middle of the bottom surface of the mold, and the recess is communicated with an exterior of the mold via a guiding groove defined in the mold.

9. The method of claim 7, wherein the aerogel solution in the room is dried by a carbon dioxide supercritical drying method.
